(19) United States
(12) Patent Application Publication
(10) Pub. No.: US 2012/0154285 A1
(43) Pub. Date: Jun. 21, 2012

(54) DISPLAY DEVICE

(75) Inventor: Naoyuki NAGAO, Shinagawa (JP)

(73) Assignee: FUJITSU COMPONENT LIMITED, Tokyo (JP)

(21) Appl. No.: 13/326,004

(22) Filed: Dec. 14, 2011

(30) Foreign Application Priority Data
Dec. 15, 2010 (JP) 2010-279501

(51) Int. Cl. G09G 5/00

(52) U.S. Cl. 345/168

(57) ABSTRACT

A display device including: a plurality of push buttons each that includes a display unit displaying an image at a upper surface of the push button, the upper surface being movable up and down, and information being input to the push button depending on a position of the upper surface; and a plurality of actuators that actuate the respective push buttons up and down independently of the up-and-down movement of the upper surfaces of the push buttons.

### CROSS-REFERENCE TO RELATED APPLICATION

This application is based upon and claims the benefit of priority of the prior Japanese Patent Application No. 2010-279501, filed on Dec. 15, 2010, the entire contents of which are incorporated herein by reference.

### FIELD

A certain aspect of the embodiments discussed herein is related to a display device.

### BACKGROUND

A display device is used for a computer terminal, a mobile phone, a game machine, an automatic vending machine, and so on. In recent years, the display device and an input device are unified using a touch panel. A patent document 1 (Japanese Laid-Open Patent Publication No. 2001-282433) discloses a technique that forms a display panel by arranging two or more push buttons, has a push button switch function by depression, and displays button icon images on the display panel. Thereby, it is easy to depress the buttons in the display device. Moreover, the depression can be recognized. A patent document 2 (U.S. Patent Publication No. 2008/0001787) discloses a technique that installs a display function into the push buttons.

However, in the technique described in the patent document 1, a mechanism which moves each of the push buttons up and down and a mechanism which depresses each of the push buttons are common. Therefore, complicated functions cannot be given to the display device.

### SUMMARY

According to an aspect of the present invention, there is provided a display device including: a plurality of push buttons each that includes a display unit displaying an image at a upper surface of the push button, the upper surface being movable up and down, and information being input to the push button depending on a position of the upper surface; and a plurality of actuators that actuate the respective push buttons up and down independently of the up-and-down movement of the upper surfaces of the push buttons.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a top view of a display device according to a first embodiment;

FIG. 1B is a top view of each of bush buttons;

FIGS. 2A and 2B are cross-sectional diagrams of each push button of the first embodiment;

FIGS. 3A to 3D are cross-sectional diagrams of each push button in which an actuator is installed;

FIG. 4 is a block diagram of the display device according to the first embodiment;

FIG. 5 is a flowchart illustrating a process which a controller of the display device executes according to a second embodiment;

FIG. 6 is a diagram illustrating an image displayed on a display panel;

FIG. 7 is a flowchart illustrating a process in step S16 of FIG. 5 which a control unit of the display device executes according to a second embodiment;

FIG. 8 is a cross-sectional diagram explaining the operation of the push buttons in an area 46 (part 1);

FIG. 9 is a cross-sectional diagram explaining the operation of the push buttons in the area 46 (part 2);

FIG. 10 is a cross-sectional diagram explaining the operation of the push buttons in the area 46 (part 3); and

FIG. 11 is a diagram illustrating images displayed on the display panel according to a third embodiment.

### DESCRIPTION OF EMBODIMENTS

A description will now be given of an exemplary embodiment with reference to the accompanying drawings.

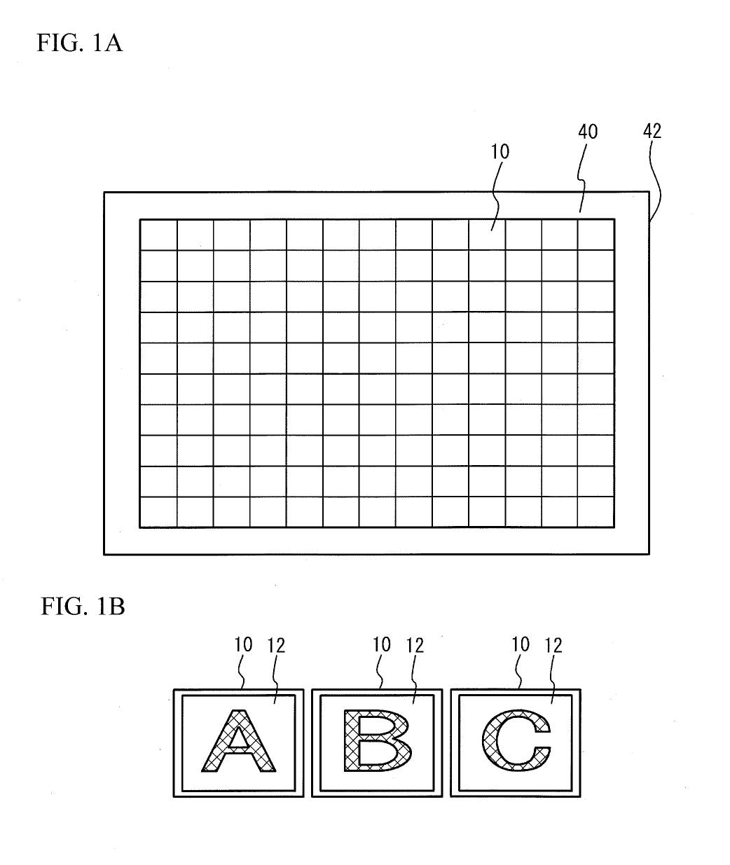

FIG. 1A is a top view of a display device according to a first embodiment, and FIG. 1B is a top view of each of push buttons. As illustrated in FIG. 1A, a display device 42 includes a display panel 40. The display panel 40 is constituted by plural push buttons 10 arranged in a transverse direction. The plural push buttons 10 are arranged in two dimensions and in two directions which intersect perpendicularly. The plural push buttons 10 may be arranged in two intersected directions or in one dimension.

As illustrated in FIG. 1B, each of the push buttons 10 includes a display unit 12. The display unit 12 is an organic electroluminescence (EL) element or a liquid crystal display (LCD) element. The display unit 12 can display a different image for each of the push buttons 10. In an example of FIG. 1B, the respective display units 12 display characters “A”, “B”, and “C”. The image to be displayed on the display unit 12 may be an image other than the characters. The push buttons 10 may be the push buttons described in U.S. Patent Publication No. 2008/0001787.

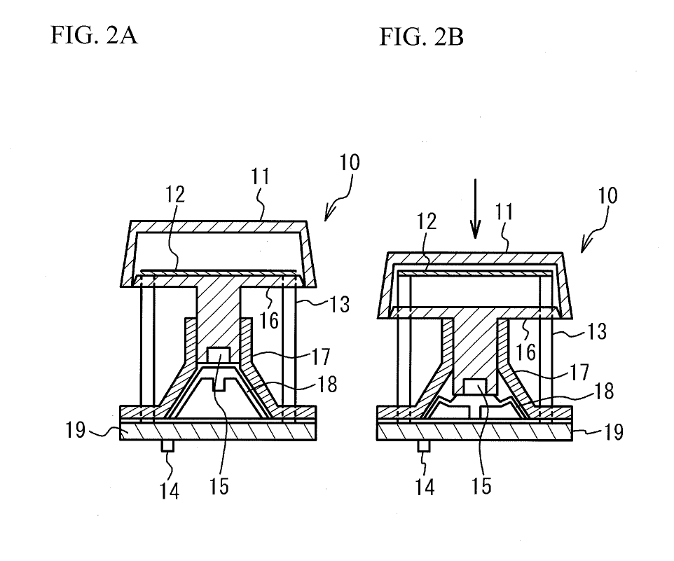

FIGS. 2A and 2B are cross-sectional diagrams of each push button of the first embodiment. FIG. 2A illustrates a state where the push button 10 is not depressed, and FIG. 2B illustrates a state where the push button 10 is depressed. As illustrated in FIGS. 2A and 2B, the push button 10 is fixed on a substrate 19 on which wiring is formed, and the display unit 12 is fixed with a support 13. The display unit 12 is housed in a space formed by a cap 11 and a cap lower part 16. At least upper surface of the cap 11 is transparent. Therefore, an image displayed on an upper surface of the display unit 12 can be viewed from the upper surface. Also when the cap 11 and the cap lower part 16 are united and slid (i.e., they move up and down), the display unit 12 remains fixed to the substrate 19 with the support 13. In addition, the display unit 12 may be fixed to the cap 11. However, in this case, the wiring connecting between the display unit 12 and the substrate 19 moves. Thereby, the disconnection of the wiring occurs easily. Therefore, it is desirable that the display unit 12 is fixed to the substrate 19.

A convex part of the cap lower part 16 is inserted into a hole of a guide unit 17 fixed to the substrate 19. When the cap 11 and the cap lower part 16 are slid, the guide unit 17 guides the convex part of the cap lower part 16. Thereby, the cap 11 and the cap lower part 16 can move up and down. A rubber dome 18 is provided in the guide unit 17. A protrusion of the rubber dome 18 abuts on the convex part of the cap lower part 16. The rubber dome 18 is an elastic body which biases the upper surface of the push button 10 upward. When the upper surface of the cap 11 is depressed as illustrated in an arrow of FIG. 2B, the rubber dome 18 is transformed and the cap 11 and the cap lower part 16 lower. When the upper surface of the cap 11 is released as illustrated in FIG. 2A, the rubber dome 18 returns to an original form, and hence the cap 11 and the cap lower part 16 go up.

A magnet 15 is provided on at least one of the cap 11 and the cap lower part 16. A magnetic sensor 14 such as a hole sensor is provided on the substrate 19. The magnetic sensor 14 can detect a position of the cap 11 by detecting the intensity of a magnetic field. The positions of the magnetic sensor 14 and the magnet 15 may be inverted. To shorten wiring of the magnetic sensor 14, it is desirable that the magnetic sensor 14 is provided on the substrate 19. Further, another means such a switch may be used for the detection of the position of the cap 11. The position of the upper surface of the push button 10 (e.g. the upper surface of the cap 11) can be not only binarized but detect in detail by using the magnetic sensor 14 and the magnet 15.

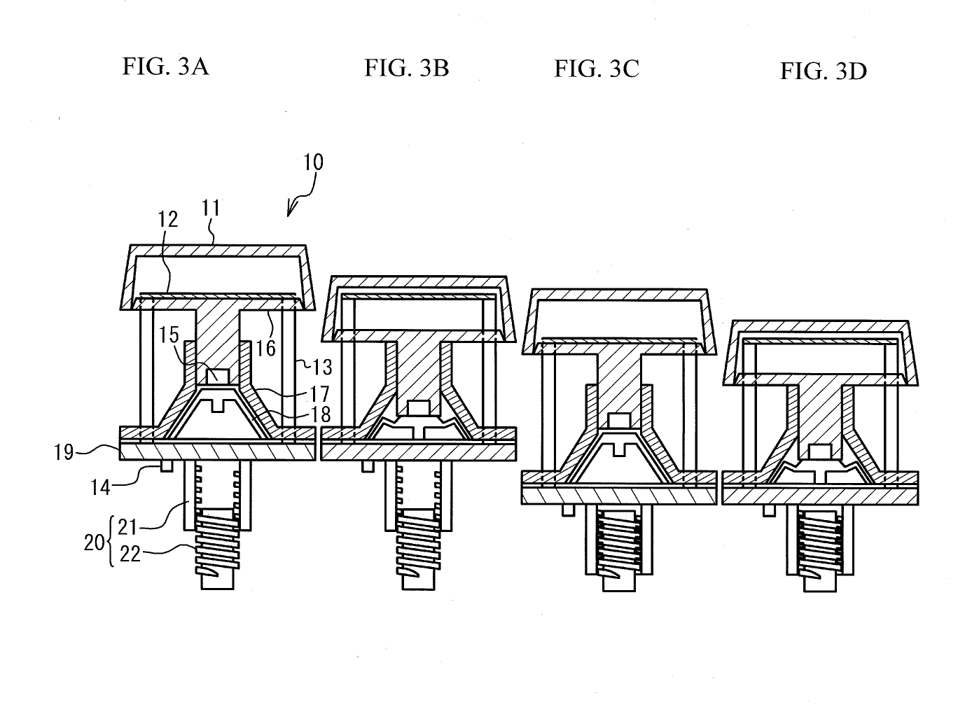

FIGS. 3A to 3D are cross-sectional diagrams of each push button in which an actuator is installed. In FIGS. 3B to 3D, the numeral codes of the same members as FIG. 3A are omitted. As illustrated in FIGS. 3A to 3D, an actuator 20 is installed under the push button 10, and the actuator 20 includes a female screw 21 and a male screw 22. The height of the push button 10 is changeable by fixing the female screw 21 to the substrate 19 and rotating the male screw 22 using a motor. FIG. 3A illustrates a state where the actuator 20 makes the position of the push button 10 high and the push button 10 is not depressed. FIG. 3B illustrates a state where the actuator 20 makes the position of the push button 10 high and the push button 10 is depressed. FIG. 3C illustrates a state where the actuator 20 makes the position of the push button 10 low and the push button 10 is not depressed. FIG. 3D illustrates a state where the actuator 20 makes the position of the push button 10 low and the push button 10 is depressed. Other mechanisms may be used as the actuator 20, as long as the actuator 20 can change the height of the push button 10.

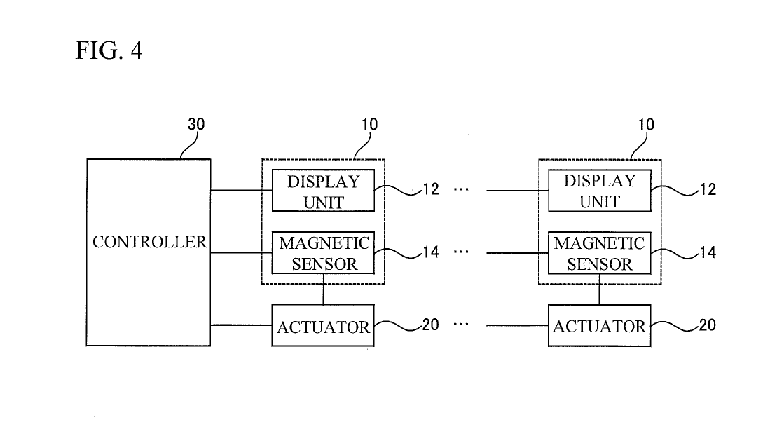

FIG. 4 is a block diagram of the display device according to the first embodiment. The display device includes plural push buttons 10, plural actuators 20, and a controller 30, as illustrated in FIG. 4. Each of the push buttons 10 includes the display unit 12 and the magnetic sensor 14. The controller 30 is a computer or a CPU (Central Processing Unit), for example. The controller 30 displays an image on the display unit 12. In addition, the controller 30 can detect the position of the upper surface of each push button 10 depending on a signal from the magnetic sensor 14. Information is input depending on the position of the upper surface of the push button 10. For example, the information is input when the push button 10 is depressed, as illustrated in FIGS. 3B and 3D. The information is not input when the push button 10 is not depressed, as illustrated in FIGS. 3A and 3C. The actuator 20 can move the push button 10 up and down.

According to the first embodiment, each of the push buttons 10 includes the display unit 12 displaying the image at the upper surface of each of the push buttons 10, and the upper surface is movable up and down. The information is input depending on the position of the upper surface of the push button 10. The actuator 20 actuates each of the push buttons 10 up and down independently of the up-and-down movement of the upper surface of each of the push buttons 10. Thereby, complicated functions as illustrated in the following second and third embodiments can be given of the display device 42.

### Second Embodiment

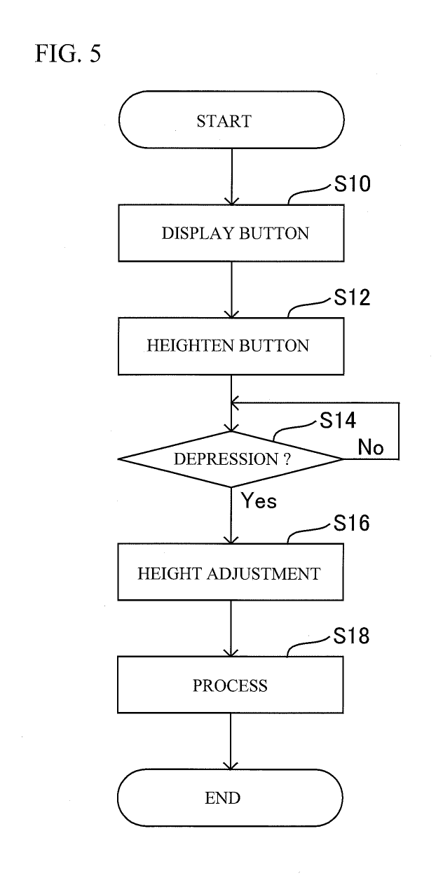

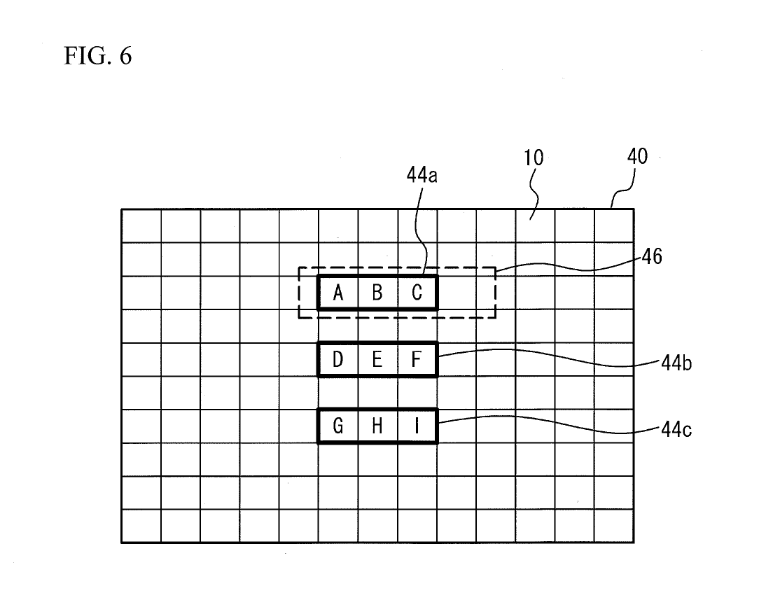

The second embodiment illustrates an example of the operation of the display device 42 according to the first embodiment. FIG. 5 is a flowchart illustrating a process which the controller of the display device executes according to the second embodiment. In FIG. 5, the controller 30 displays at least one button icon on the display panel 40 (step S10). FIG. 6 illustrates button icons displayed on the display panel 40. The button icons 44a to 44c are displayed on the display panel 40, as illustrated in FIG. 6. Each of the button icons 44a to 44c includes three push buttons 10, for example. Each of the button icons 44a to 44c may be composed of two or more push buttons 10, for example. Each of the button icons 44a to 44c is formed from images displayed on the display units 12 of the push buttons 10.

As illustrated in FIG. 5, the controller 30 controls the actuators 20 to make the push buttons 10, included in the button icons 44a to 44c, higher than other push buttons 10 (step S12). The controller 30 judges whether any one of the button icons 44a to 44c is depressed (step S14). When at least one push button 10 included in the button icon 44a is depressed, for example, the controller 30 judges that the button icon 44a is depressed. When the position of the upper surface of the push button 10 lowers from a given position, for example, the controller 30 can judge that the push button 10 is depressed.

When the answer to the judgment of step S14 is NO, the procedure returns to step S14. When the answer to the judgment of step S14 is YES (e.g. it is assumed that the button icon 44a is depressed), the controller 30 adjusts the height of the upper surfaces of the push buttons 10 included in the button icon 44a (step S16). The controller 30 performs a process corresponding to the depression of the button icon 44a (step S18). Then, the procedure terminates and returns to step S10.

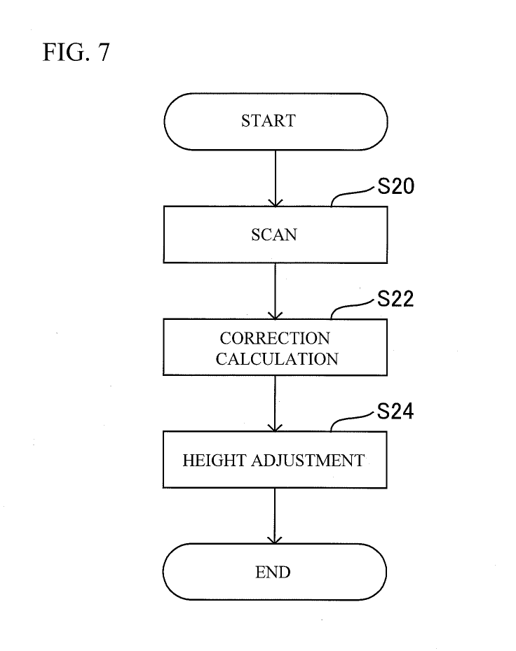

FIG. 7 is a flowchart illustrating the process performed by the controller in step S16 of FIG. 5. As illustrated in FIG. 7, the controller 30 scans the push buttons 10 included in the depressed button icon 44a (step S20). For example, the controller 30 performs raster scan. For example, the controller 30 measures the position of the upper surface of each push button 10 included in the button icon 44a. The controller 30 calculates a correction value of the position of the upper surface of each push button 10 included in the button icon 44a (step S22). For example, the controller 30 calculates a difference between the lowest position of the upper surface of the push button 10 included in the button icon 44a and the other positions of the upper surfaces of other push buttons 10 included in the button icon 44a. The controller 30 causes the actuator 20 to adjust the height of each push button 10 included in the button icon 44a (step S24). For example, the controller 30 controls the actuator 20 to align the height of the upper surface of each push button 10 included in the button icon 44a with the lowest position of the upper surface measured in step S22.

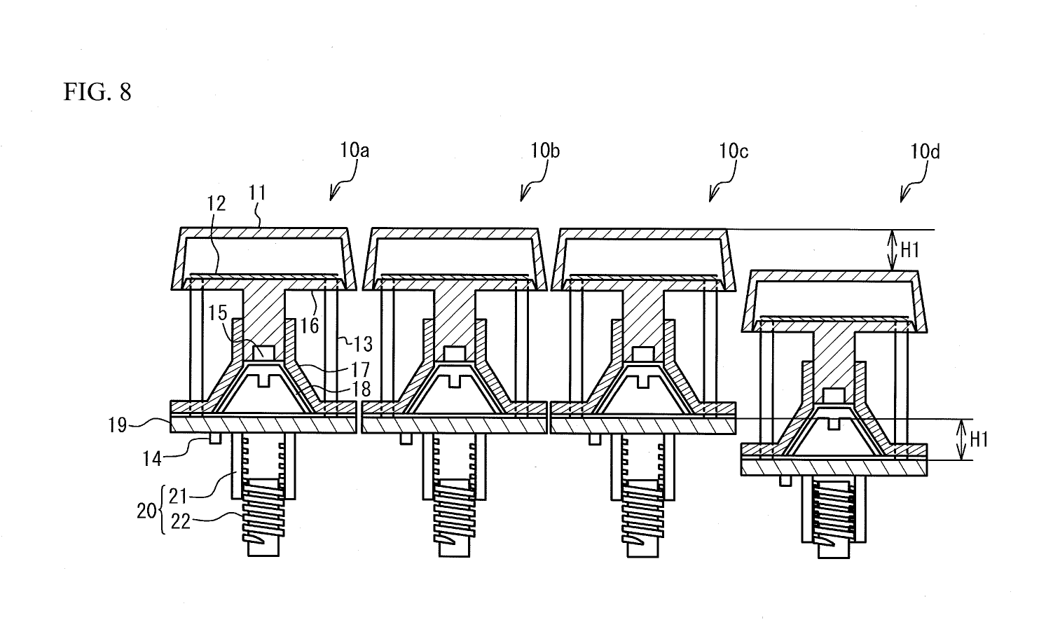

FIGS. 8 to 10 are cross-sectional diagrams explaining the operation of the push buttons in an area 46 of FIG. 6. In FIGS. 8 to 10, the push buttons 10a to 10c form the button icon 44a, i.e., are included in the button icon 44a. The push button 10d is not included in the button icons 44a to 44c. In the push buttons 10b to 10d, reference numbers of the same members as the push button 10a are omitted.

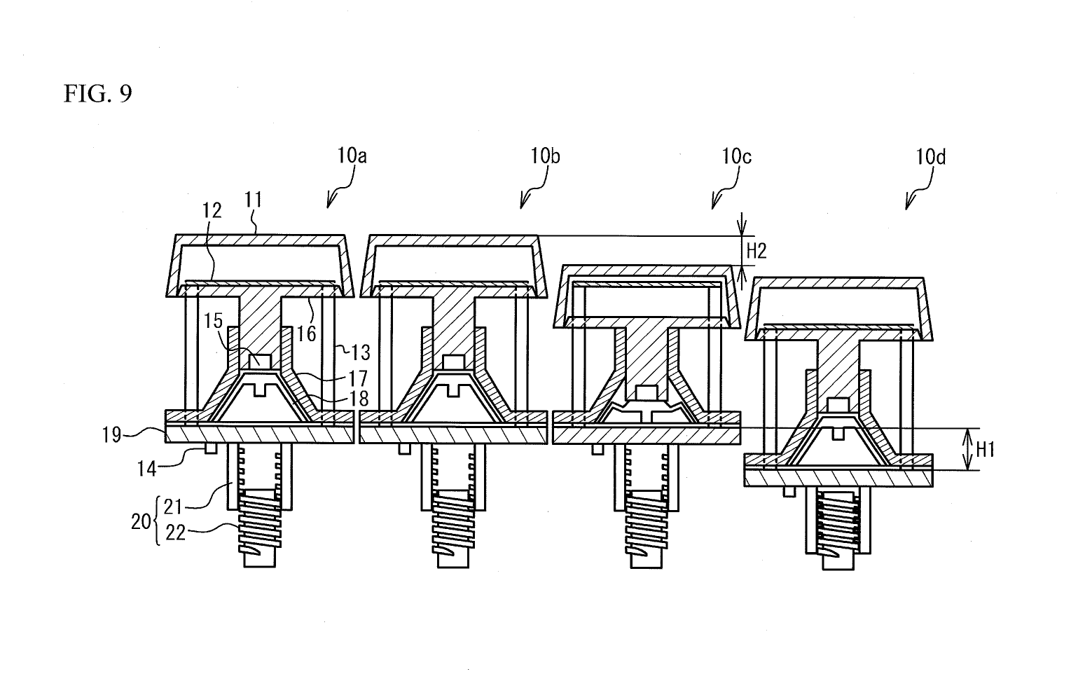

FIG. 8 illustrates the push buttons 10a to 10d after step S12 of FIG. 5. The actuators 20 heighten the push buttons 10a to 10c included in the button icon 44a. Thereby, the upper surfaces of the push buttons 10a to 10c become higher than that of the push button 10d by height H1. FIG. 9 illustrates the push buttons 10a to 10d after step S20 of FIG. 7. In the push buttons 10a to 10c included in the button icon 44a, the upper surface of the push button 10c become lower than the upper surfaces of the push buttons 10a and 10b by height H2. FIG. 9 illustrates the push buttons 10a to 10d after step S24 of FIG. 7. The actuators 20 of the push buttons 10a and 10b actuate, and the height of the push buttons 10a to 10c is adjusted so as to align the upper surfaces of the push buttons 10a and 10b with the upper surface of the push button 10c. For example, the actuators 20 make the substrates 19 of the push buttons 10a and 10b lower than the push button 10c by height H2. In FIGS. 8 and 9, the description is given of an example of the case where the single push button 10c in the push buttons 10a to 10c is depressed. However, the plural push buttons in the push buttons 10a to 10c may be depressed.

According to the second embodiment, as illustrated in step S12 of FIG. 5 and FIG. 8, the controller 30 controls the actuators 20 to make the upper surfaces of some push buttons (e.g. the push buttons 10a to 10c corresponding to the button icon 44a) in the plural push buttons 10 higher than the upper surface of other push button 10d. Thereby, images with different height can be displayed on the display panel 40. For example, by making an image of the button icon higher than other images, the button icon can be further emphasized. In addition, a user can enjoy an exciting image in a game machine

When the upper surface of at least one push button 10a in some push buttons, e.g. the push buttons 10a to 10c, is depressed, the controller 30 controls the actuators 20 to adjust the height of the upper surfaces of the push buttons 10a to 10c. For example, the controller 30 controls the actuators 20 to align the height of the upper surfaces of the push buttons 10a to 10c. That is, the controller 30 controls the actuators 20 to align the height of the upper surfaces of the push buttons 10b and 10c with the height of the upper surface of the push button 10a. Thereby, the height of the push buttons 10a to 10c included in the button icon 44a can be integrally and simultaneously aligned with each other. The height of the upper surfaces of the push buttons 10a to 10c do not necessarily need to align. For example, by making the upper surface of a central push button included in the button icon higher or lower than the upper surfaces of adjacent push buttons included in the button icon, the button icon can be further emphasized. In the game machine, the push buttons can be set to a more stimulative form.

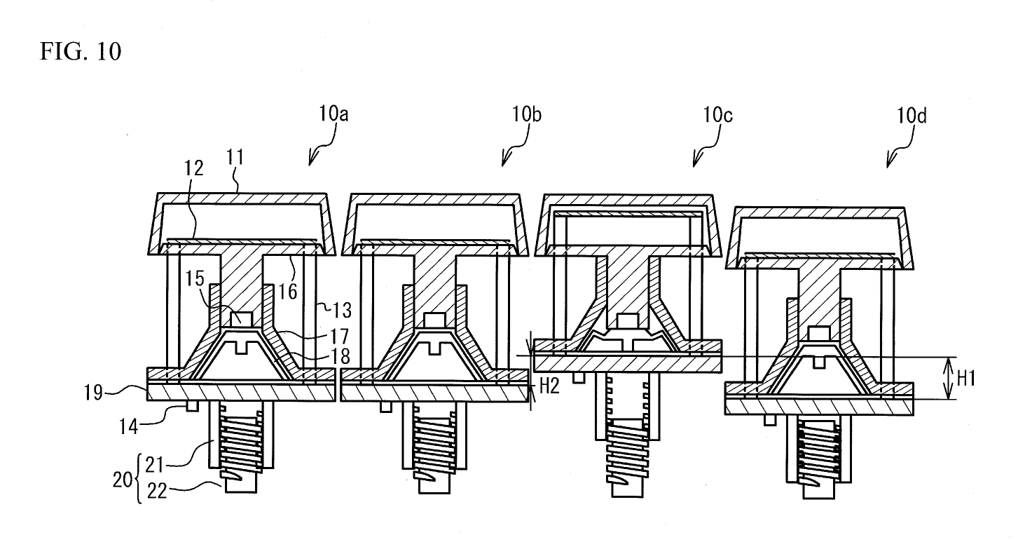

As illustrated in FIG. 10, the controller 30 controls the actuators 20 to align the upper surfaces of the push buttons 10a and 10b with the lowest upper surface of the push button 10c in the upper surfaces of the push buttons 10a to 10c. Thereby, it is not necessary to actuate the actuator 20 of the push button 10c, and it is more efficient.

### Third Embodiment

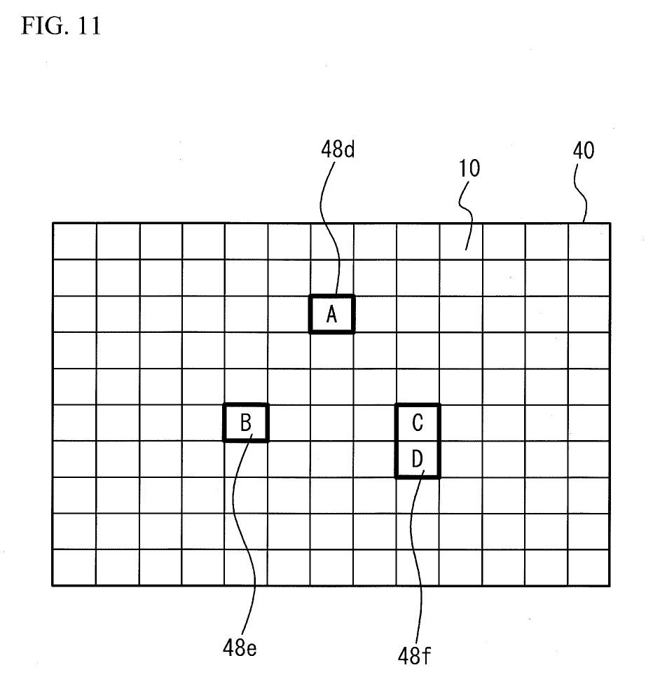

The third embodiment illustrates an example of the operation of the display device 42 according to the first embodiment. FIG. 11 illustrates an example of images displayed on the display panel 40 according to a third embodiment. As illustrated in FIG. 11, the push buttons included in areas 48d, 48e and 48f are some push buttons having the upper surfaces to be interlocked and adjusted. Thus, some push buttons to be interlocked and adjusted may not be adjacent to each other, and may be separated into plural positions. For example, when plural interlocking push buttons are provided on the display panel 40 in the game machine, the user can enjoy a more exciting game. When the method of the patent document 1 (Japanese Laid-Open Patent Publication No. 2001-282433) is used, the interlocking push buttons cannot be separated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A display device comprising:
a plurality of push buttons each that includes a display unit displaying an image at a upper surface of the push button, the upper surface being movable up and down, and information being input to the push button depending on a position of the upper surface; and
a plurality of actuators that actuate the respective push buttons up and down independently of the up-and-down movement of the upper surfaces of the push buttons.

2. The display device according to claim 1, further comprising a display panel that is formed with the display units of the push buttons.

3. The display device according to claim 1, further comprising a controller that controls the actuators to make the upper surfaces of some push buttons included in the plurality of push buttons higher than the upper surfaces of other push buttons.

4. The display device according to claim 3, wherein when at least one upper surface in the some push buttons is depressed, the controller controls the actuators to adjust the height of the upper surfaces of the some push buttons.

5. The display device according to claim 3, wherein when at least one upper surface in the some push buttons is depressed, the controller controls the actuators to align the height of the upper surfaces of the some push buttons.

6. The display device according to claim 3, further comprising a display panel that is formed with the display units of the push buttons, wherein the controller displays on the display panel a button icon formed by images, by causing the display units of the some push buttons to display the images.

7. The display device according to claim 5, wherein the controller controls the actuators to align the upper surfaces of the some push buttons with the lowest upper surface in the upper surfaces of the some push buttons.

8. The display device according to claim 3, wherein the some push buttons are separated without being adjacent to each other.
